(19) United States
(12) Patent Application Publication
(10) Pub. No.: US 2021/0122103 A1
(43) Pub. Date: Apr. 29, 2021

(54) METHOD FOR PRODUCING A COMPOSITE PROFILED SECTION AND COMPOSITE PROFILED SECTION

(71) Applicant: OKE Group GmbH., Ummerstadt (DE)

(72) Inventors: Andreas Bartel, Rheine (DE); Thorsten Fichtner, Horstel (DE); Alexander Epp, Ibbenburen (DE); Alexander Rudsinski, Rheine (DE)

(73) Assignee: OKE Kunststofftechnik GmbH & Co. KG, Ummerstadt (DE)

(21) Appl. No.: 16/617,046

(22) PCT Filed: Jul. 10, 2018
(86) PCT No.: PCT/EP2018/068657

§ 371 Date: Nov. 26, 2019

(30) Foreign Application Priority Data
Jul. 12, 2017 (DE) 10 2017 006 688.4
Aug. 28, 2017 (DE) 10 2017 008 055.0
Oct. 23, 2017 (DE) 10 2017 009 839.5

(51) Int. Cl. B29C 53/56; B29C 48/00; B29C 48/06; B29C 48/09; B29C 48/154; B29C 48/151

(52) U.S. Cl. CPC B29C 53/56; B29C 48/0019; B29C 48/06; B29K 2105/04; B29C 48/154; B29C 48/151; B29C 48/09

(57) ABSTRACT

The invention concerns a method for the production of a composite profiled section (3) comprising a core (1) and a shell (2), in particular intended for use as a reinforcing element or reinforcing rod in a, preferably thermoplastic, plastic material and/or for use as a reinforcing rod for a spring clip (11), wherein the shell (2) has shell fibres (4) which are laid around the circumference of the core (1), wherein, subsequent to the application of the shell fibres (4) to the core (1), at least one supporting fibre (5) is wound around the shell fibres (4) applied to the core (1) by means of a winding device for the production of a preformed pre-composite profiled section (6). As an alternative and/or in addition thereto, a method for producing an aforementioned composite profiled section (3) is provided, wherein the core (1) is produced continuously by foam extrusion with at least one extruder.

The invention concerns a method for producing a composite profiled section, in particular intended for use as a spring clip. Furthermore, the invention concerns a composite profiled section, in particular provided as a reinforcing element and/or reinforcing rod in a, preferably thermoplastic, plastic material and/or for use as a reinforcing rod for a spring clip, preferably produced by the aforementioned method. Furthermore, the invention concerns a spring clip with an aforementioned composite profiled section and with a jacket.

From the state of the art, a one-piece design of the composite profiled section for use within a spring clip and/or as a reinforcing rod is known. This one-piece composite profiled section has the shape of a solid body, in particular a solid rod. The one-piece composite profiled sections known from practice provide the use of a glass-fibre reinforced synthetic plastic as material. Accordingly, the production of a one-piece composite profiled section results in high production costs due to the high material costs. In addition, the one-piece fibre-reinforced plastic composite profiled section has a high weight

Irrespective of the one-piece composite profiled section and irrespective of the use in the production of a spring clip, at least two-piece composite profiled sections are also known in practice. The two-piece version of the composite profiled section has a core and a shell surrounding the core. The shell, on the other hand, can feature a fibre-reinforced plastic material.

In order to produce the aforementioned composite profiled sections, a shaping tool and/or a hardening element is required to shape the pre-composite profiled section. This additional method step to produce the composite profiled section makes the entire production process more complicated. The disadvantage of the shaping tool is that it significantly impairs and/or reduces the production speed. Before further processing of the aforementioned composite profiled section, complete hardening must be ensured in order to avoid possible deformation and/or alteration of the cross-section. This excludes the use of an aforementioned composite profiled section within an inline manufacture in which the composite profiled section can at least substantially be further processed immediately after its production.

The problem which this invention proposes to solve is, first of all, to provide a novel method for the production of a composite profiled section, whereby the disadvantages in the state of the art are avoided or reduced as far as possible. In particular, it is the task of the present invention to realize a continuous inline process, in particular for the production of a spring clip and/or a reinforcing rod surrounded by a, in particular thermoplastic, plastic material. In addition, it is particularly the task to carry out the method in a few process steps and at low cost. Furthermore, it is in particular the task of the present invention to provide a composite profiled section, in particular intended for use as a spring clip, which has a low weight and/or can be produced at low cost.

In a method of the type mentioned above, the aforementioned task is at least substantially solved by the fact that the composite profiled section has a core and a shell, the shell having shell fibres which are laid around the circumference of the core.

According to a first embodiment of the method, following the application of the shell fibres to the core, at least one supporting fibre is wound around the applied shell fibres by means of a winding device to produce a composite profiled section as described above.

As an independent alternative and/or in addition to the previous embodiment of the method of wrapping the shell fibres with a supporting fibre, it is provided according to the invention that the core is continuously produced by foam extrusion with at least one extruder.

First of all, the essential advantages resulting from the division of the composite profiled section into a core and a shell enclosing the core are explained.

Ultimately, it is understood that the shell enveloping the core does not enclose the end faces of the core, but surrounds the core radially. The shell can preferably be designed as a hollow profile, whereby no adhesive layer and/or joint is required between the shell and the core.

In comparison to the design of the composite profiled section as a single solid body, in particular as a solid rod, the composite profiled section according to the invention offers the advantage of a material saving, in particular of the fibre-reinforced plastic, preferably by up to 60%. This material to be saved leads among other things to a reduction of the total production costs, in particular up to 30%. Tests have shown that the shear stress is mainly transferred to the hollow profile of the shell of the composite profiled section. In particular, the inner core is not used to compensate the compressive and/or shear stresses, but is required for production reasons and/or to support the shell. The production with the core according to the invention can be carried out more easily, since the material of the shell wraps itself around the core and is supported by it The core does not have to be subsequently removed from the composite profiled section, especially in comparison to a particularly stationary pin, before the composite profiled section can be used as reinforcement and/or reinforcing rod for a spring clip and/or as reinforcing rod.

Preferably, the composite profiled section according to the invention is used together with a protective shell and/or jacket comprising a thermoplastic and/or thermosetting (duroplastic) plastic as a reinforcing rod and/or reinforcing element.

It is particularly advantageous that by varying the wall thickness and/or the size of the shell, different properties of the composite profiled section can be created, in particular mechanical properties and/or properties relating to bending behavior, so that in particular corresponding “hard” and/or “soft” composite profiled sections are provided which can, for example, be used for the production of in particular “hard” and/or “soft” spring slats.

In particular, the surface of the shell may be mechanically hooked to the surface of the core facing the inside of the shell. According to the invention, a mechanical interlocking and/or connection does not necessarily have to be provided, since the inner core is not necessary to compensate for the mechanical loads on the composite profiled section.

Tests have shown that a spring clip with a composite profiled section according to the invention and a jacket almost completely achieves the properties of a spring clip with a fully cylindrical composite profiled section made of fibre-reinforced plastic. Compared to the composite profiled section made exclusively of fibre-reinforced plastic material, production costs and/or production time can be reduced.

It could also be established that a load on the spring clip is primarily equalized and/or compensated by the outsides of the composite profiled section, in particular the shell.

In addition, in particular the use of a core in a composite profiled section is more environmentally friendly than the use of a composite profiled section made entirely from the material of the shell of the composite profiled section in accordance with the invention, since a reduction in the fibre-reinforced material can be achieved. In particular, less fibre-reinforced plastic material, in particular fewer glass fibres and/or less resin, is required in the production process of an inventive spring clip

In addition to the pure material savings through the separation of the composite profiled section into a core and a shell, the set-up times before the start of production are reduced since fewer glass fibre coils have to be used.

The composite profiled section according to the invention is preferably provided with a larger outer diameter in comparison to a composite profiled section exclusively comprising fibre-reinforced plastic. When loading a spring clip in which a composite profiled section is clamped, the force is distributed over the cross-section of the composite profiled section. The larger the cross-sectional area, the better the load can be balanced and the smaller are the stress peaks in particular. The smaller the cross-sectional area, the more difficult it is to absorb forces and the more likely it is that higher stress peaks will occur. In the tests carried out, it was shown that the outer jacket of a composite profiled section is primarily subjected to a load, whereby a better force distribution results with a larger cross-sectional area of the composite profiled section. With the composite profiled section according to the invention, it is possible in particular to produce broader spring clips with improved force absorption at lower cost.

The first possible embodiment of the method according to the invention shows the wrapping of the shell fibres with at least one supporting fibre. This wrapping with the supporting fibre achieves various advantages. It is particularly advantageous that a tool for shaping and/or a hardening element for shaping the composite profiled section before and/or after the wrapping with the supporting fibre can be omitted. The shape of the composite profiled section or the pre-composite profiled section is achieved due to the supporting fibre. In particular, cylindrical and/or rod-shaped composite profiled sections can be produced in this way. The method step for shaping, which is provided in the state of the art after the shell fibres have been applied to the core, can be omitted so that, in particular, the pre-composite profiled section does not have to be guided through another tool, in particular through a gap, before and/or after wrapping with the supporting fibre. In particular, this enables a higher throughput speed and reduces the machine components to be maintained. This results in a reduction of machine costs and in particular of operating costs.

The wrapping of the shell fibres with the supporting fibre stabilizes the pre-composite profiled section, especially if the pre-composite profiled section has not yet completely hardened. This partial hardening is achieved in a sufficient manner, with areas being kept free because of the spirally shaped wrapping.

According to a first preferred alternative, it is foreseen that the material of the shell and/or core or composite profiled section is compressed by the supporting fibre, so that the non-wrapped areas have an increased outer circumference and the outer circumference of the composite profiled section is reduced in the areas wrapped with the supporting fibre.

Another second alternative is to reduce the outer circumference of the composite profiled section in the non-wrapped areas.

The compression of the composite profiled section material, especially after the first wrapping alternative described above, may be provided inside and/or after the heating device. The material of the shell and/or the core is preferably compressed and/or compacted by the supporting fibre.

The wrapping, in particular during hardening of the reaction resin on the outside of the fibre bundle, forms a fibre composite plastic with a matrix of the shell fibres, preferably running in the longitudinal direction, and the supporting fibres, preferably running almost transversely, from the wrapping. This results in a stable shell structure on the outside of the pre-composite profiled section, even if this initially outer area of the cross-section is not completely hardened. Due to the preferred multi-axial fibre flow in the outer area of the pre-composite profiled section, however, the pre-composite profiled section is stable enough to be fed to further production steps in this state. Preferably, these further production steps consist of producing a spring clip strand.

A major advantage of this method is that it can be carried out continuously, especially during the production of the core according to the second alternative of the embodiment of the method, and that first an endless profile of the composite profiled section is obtained. If necessary, this endless profile can be continuously fed to another machine, in which it is preferably surrounded by a jacket, so that a strand of spring clips can be produced in an inline method. The inline method enables high processing speeds, low production costs and high throughput The storage capacity can be reduced because the individual components of the spring clip can be handled directly, i.e. without intermediate storage.

It is of particular advantage that a complete hardening of the pre-composite profiled section does not have to be guaranteed before the composite profiled section is fed to the extrusion machine of the jacket, in particular the extrusion of a thermoplastic. Preferably, the composite profiled section is post-hardened even after the jacket has been extruded on, especially up to the storage time of the spring slats which have already been externally finished and especially packed. Here the reaction heat is utilized, which arises when a suitable reaction mixture is used, which leads to an exothermic cross-linking reaction, preferably in the formation of polyester. The use of a thermoplastic jacket has the advantage that it has a heat-insulating effect, so that the heat generated by the exothermic reaction, preferably in the reaction resin, is not dissipated to the environment, but contributes to faster hardening from the inside out. In order to enable such a post-hardening in the first place, a partially hardened composite profiled section is required, which is ensured in particular only by the wrapping with the supporting fibre according to the invention.

Advantageously, with the inline method in accordance with the invention, throughput speeds of at least 4 m/min, preferably between 4 m/min and 10 m/min, and further preferably between 7 m/min and 8 m/min, can be achieved, whereas throughput speeds with a conventional pultrusion method are in the range of 1 m/min to 3 m/min.

As a result of the method according to the invention, there is no speed deficit in the production process. In addition, it is advantageous that the hardening of the shell is completed more quickly than in the production of a composite profiled section which exclusively comprises glass fibre reinforced plastic.

In principle, it is also conceivable that, in another preferred form of the process, foaming of the core takes place after application of the shell fibres, in particular using a nucleating agent It may be provided that the foamed core is only generated during the production of the composite profiled section, in particular after the shell fibres of the shell have been applied and/or arranged on the outside of the core.

In addition, it has been shown that a surface of the composite profiled section jacketed by a supporting fibre is better bonded to a jacket, in particular of the spring clip strand. This jacket can be applied and/or extruded onto the composite profiled section to produce a slat strand. Due to the rougher surface structure of the composite profiled section, there is a better mechanical interlocking and/or connection with the material of the jacket of the spring clip. In particular, this eliminates the need for an adhesive layer and/or individual bonding points. A better mechanical connection of the composite profiled section with the jacket leads to a spring clip that can particularly withstand higher bending stresses.

Furthermore, various advantages are also achieved by foam extrusion of the core according to the alternative and/or supplementary variant of the method. The extrusion and continuous production of the core ensures that a high production speed is maintained. Particularly with regard to the production speed, the combination of the extrusion with the wrapping of the shell fibres with a supporting fibre is particularly advantageous. However, the extrusion not only achieves a fast speed of the production sequence, but also lower production costs of the composite profiled section, especially in the inline method.

During extrusion, plastics are pressed through a die in a continuous method. The extrudate is first melted and/or homogenized by an extruder, preferably by means of heating and internal friction. Furthermore, the pressure required for the flow through the die is built up in the extruder. After exiting the die, the extrudate solidifies, preferably in the cross-section of the resulting geometric body. This cross-section corresponds in particular to the die used and/or the calibration. These resulting, especially seamless, profiles can have a constant cross-section, so that any length can be made available. The possibility according to the method of providing a constant cross-section profile is particularly suitable for the production of a composite profiled section with a constant cross-section, so that it is preferably possible to guarantee that the core always has the same dimensions.

The production of the foam by means of at least one extruder offers the advantage, in particular in comparison to the use of a prefoamed material, that the core can theoretically be supplied in any and/or infinite length to the production method of the composite profiled section. If the core was cut in advance from a foam block, for example, an additional method step of providing the core shape would result. In foam extrusion by means of an extruder, the preferred design of the core is already guaranteed in the form of a rod or a rod or at least essentially in cylindrical form. In the continuous production of the core, there is no point of joining and/or bonding of individual core pieces, so that a predetermined breaking point is avoided.

Ultimately, it is understood that the individual method alternatives can be carried out independently or together according to the invention. The combination of both alternatives in the design of the method opens up the possibility that the core can be produced as an endless strand and continuously fed to the machine for producing the composite profiled section. It is also understood that it is ultimately also possible to first produce the strand of the core, to temporarily store it on a roll wound and/or rolled up and then use it to manufacture the composite profiled section.

In a preferred version of the method according to the invention of producing a composite profiled section, the core is fed as a strand in an inline method. In particular, the use of the inline method enables higher processing speeds and advantageously leads to a reduction in the storage area to be maintained, since the core can be processed immediately after its production. It may be provided that the core is either first produced and then temporarily stored for a short time before being continuously fed to the production of the composite profiled section, or that the production of the composite profiled section follows directly after the production of the core.

The blowing agent required for foam extrusion can advantageously be individually adjusted in terms of quantity so that the cellular structure of the core can be attained. The core preferably has a closed-cell surface, whereby the surface structure and/or the cellular structure of the core can preferably be controlled by the blowing agent. In particular, the blowing agent ensures that the high demands on foam homogeneity, especially at low densities, can be met. The blowing agent enables better process stability and, when physical blowing agents are used, significantly lower blowing agent material costs are achieved compared to chemical blowing agents. In addition, a physical blowing agent in particular is more environmentally compatible, so that an environmentally friendly aspect of the method results.

In physical foaming, the material is foamed by a physical process. In chemical foaming, on the other hand, a blowing agent is added to the plastic granulate, preferably in the form of a masterbatch granulate. The addition of heat causes a volatile component of the blowing agent to split off, leading to foaming of the melt. In particular, physical foaming can produce a core with a compact outer skin and a so-called microcellular foam with integrated density distribution, also known as integral foam.

The blowing agent preferably contains hydrocarbons, in particular isobutane, pentane and inert gases, preferably carbon dioxide and/or nitrogen. The use of inert gases as blowing agents results in good environmental compatibility, as they have only a minimal GWP (global warming potential) and preferably no ODP (ozone depletion potential). The inert gases have a high degree of foaming so that gas consumption is particularly low. They are both economical and cost-effective. From a chemical point of view, the advantage is that they are non-combustible and/or non-toxic and/or chemically inert. In particular, no residues of this inert gas remain in the foamed core itself. The blowing agents are dosed into the material of the core, especially into the plastic melt It is understood that a suitable extrusion machine is required for extrusion foaming, which differs considerably from the known standard machines. Depending on the product, at least one extruder is used. If two extruders are used, it is conceivable that the first will be used to feed the blowing agent and homogenize the foam, while the second extruder will be used for targeted cooling of the melt loaded with the blowing agent The blowing agent is preferably injected into the extruder under high pressure via an injection pump. In particular, the amount of propellant gas can be adjusted directly and preferably adapted to the core material used and/or the foam density to be achieved. Through the diffusion, the core material/blowing agent mixture homogenizes. The pressure in the extruder must be kept constant, especially until it exits the extruder die, so that premature foaming of the core material with the blowing agent is avoided. Within the foaming process, the already existing germs grow and form foam bubbles.

In a preferred embodiment of the method, the carbon dioxide, which is used as a blowing agent, is recovered from the production process and, especially after extraction, cleaned, dried and liquefied under pressure. This treatment of the carbon dioxide is carried out in particular in such a way that the foam homogeneity of the core material to be achieved is guaranteed. In order to achieve a particularly high foam homogeneity, nucleating agents, especially for nucleation, and/or stabilizers are preferably added to the physical blowing agent. The nucleating agents act as nucleation images, forming a large number of small bubbles in particular. The core produced by means of an extrusion is thus a preproduct and is present in particular as an endless strand of foamed plastic.

In the case of an advantageous embodiment of the invention idea it is provided that the shell fibres are spread out before the jacketing of the core and covered with a plastic material. It is understood that the jacketing of the shell fibres can take place in a soaking tub and/or an impregnation bath. The shell fibres, which are impregnated in particular, are fed to the core, with the advantage that the fibres can optimally lay around the core, especially lengthwise in the production direction. Ultimately, the impregnation of the shell fibres, especially with resin, can only take place directly before the jacketing of the core. It is understood that the shell fibres do not surround the end faces of the core but the core radially and that the shell fibres form a closed composite profiled section on the side faces. In particular, the shear strength and thus the bending strength of the composite profiled section can be influenced in a suitable way by changing the wall thickness of the shell. Spreading the shell fibres allows the shell fibres to be enveloped well by the material of the shell so that, in particular, a jacketing of each shell fibre is guaranteed.

The spreading device is preferably designed in such a way that several coils are held ready at a coil creel on which the wound shell fibres are located. A fibre creel is preferred through which the wound shell fibres can be pulled off in several individual shell fibres. The individual shell fibres are then drawn through the soaking bath and/or the impregnation bath. Preferably, the material is kept permanently in its liquid and/or molten form in the impregnation bath.

In another preferred form of the present invention it is provided that the at least one supporting fibre is wound spirally shaped with a distance between the adjacent windings between 1 mm and 15 mm, preferably between 2 mm and 10 mm, preferably at least essentially between 5 mm and 7 mm. This distance makes it clear that preferably only one supporting fibre or only one bundle with a few (in particular smaller than 10) supporting fibres is required, so that the length or number of supporting fibres to be kept available can be kept small.

In the tests carried out it was shown that in particular a spirally shaped wrapping with the aforementioned winding distance has very good shaping properties and the optimum between the required supporting fibre length and the adherence to the shaping structure is achieved. It was found that the torsional stiffness is increased especially with a spirally shaped wrapping and that an improved mechanical interlocking of the composite profiled section with the jacket of the spring clip strand results advantageously.

In another embodiment it is planned that the pre-composite profiled section, after the wrapping with the backing thread, preferably in the inline method, is fed to a heating device, preferably with a throughput speed between 3 m/min to 15 m/min, preferably between 4 m/min to 10 m/min, more preferably from 7 m/min to 8 m/min, whereby the final shaping of the pre-composite profiled section can be achieved due to the heating of the pre-composite profiled section, as the material of the shell hardens and/or partly hardens and retains the adopted shape due to the supporting fibre.

In the case of a further, preferred embodiment, it is planned that a cooling device is connected to the heating device as required, preferably in order to avoid sticking and/or contamination of the following extraction device, with the final shape of the pre-composite profiled section thus being achieved due to the heating and/or cooling of the pre-composite profiled section, as described above.

Due to the hardening of the pre-composite profiled section and/or the jacket of the core with the shell, many advantages are achieved, such as the increase in torsional stiffness and the increase in compressive strength perpendicular to the surface of the semi-finished product and/or composite profiled section. Preferably, however, a complete hardening of the composite profiled section does not have to take place, if it is fed to a subsequent extrusion machine for the production of a spring clip. It is advantageous to select the throughput speed in the heating device in such a way that the stability of the outer area of the shell is chosen sufficiently high so that the stability of the composite profiled section can be maintained until the entry into the extrusion machine, wherein, in particular, the complete hardening is affected by the post-hardening process described above.

In addition, in a further embodiment it is provided that a stripping of the plastic material is carried out by means of a stripping device and/or extraction device, preferably by means of stripping bushes, preferably pneumatically. This stripping is provided in particular after the shell fibres have been wrapped with at least one supporting fibre, so that the pre-composite profiled section preferably has no excess plastic material of the shell. If this material is subsequently reused in the production process, the advantage, in addition to sustainability, is that production costs can be reduced.

In this context, it should be noted that if the method of producing different composite profiled sections is preferred, only the wall thickness of the material is varied, while the outer diameter of the core is kept constant According to the invention, this has the advantage that the production method of the core does not have to be changed by foam extrusion, so that the same settings of the extruder can always be used. A variation of the compound profile thickness results from a variation of the outer diameter of the shell. These different outer diameters can be achieved by applying a different layer thickness of the shell fibres to the core. In particular, by varying the layer thickness application, it is possible to affect the mechanical properties of the composite profiled section.

In addition, the invention at hand also concerns a spring slat strand produced from a composite profiled section in an inline method with another preferred embodiment The composite profiled section is provided with a jacket, whereby the jacket envelops and/or surrounds the composite profiled section. The embodiment according to the invention of the composite profiled section is particularly advantageous in combination with the jacket, as the composite profiled section is post-hardened even after the jacket has been extruded on, especially up to the storage period of the individual spring clips that have already been externally finished and packaged. Consequently, it is preferred that the composite profiled section does not have to be completely hardened before the jacket, so that significantly higher throughput speeds can be achieved. For jacket, a stable shell structure of the composite profiled section is provided by the spirally shaped wrapping of the supporting fibre, even if only the outer part of the shell of the composite profiled section is hardened. However, the composite profiled section is stable enough to be fed to the extrusion die and/or extrusion machine and not to change its pre-composite profiled section shape by extruding-on the jacket With the inline method according to the invention, throughput times of at least 4 m/min, preferably between 6 m/min and 9 m/min, can be achieved, whereas throughput times with a conventional pultrusion method are only in the range between 1 m/min and 3 m/min. The jacket of the composite profiled section is advantageous in that the reaction heat generated during an exothermic cross-linking reaction can be optimally utilized if a suitable reaction mixture is used. The jacket has a heat-insulating effect so that the resulting reaction heat is not dissipated to the environment and therefore contributes to a faster hardening of the composite profiled section.

In the case of an advantageous embodiment of the method, it is provided that, after the jacket has been extruded onto the composite profiled section, the pre-spring clip strand is passed through a heating section which is preferably of such length that at the increased throughput speeds no complete through-hardening, but an almost complete through-hardening, of the composite profiled section and/or of the jacket is achieved.

Preferably, the jacket formed by extrusion is applied to the composite profiled section with the same size. This avoids accumulations of material on one side in the cross-section, so that deformations of the spring clip strand during subsequent cooling are avoided. This is particularly advantageous as post-hardening is only affected after leaving the extrusion machine and/or extrusion machine.

It goes without saying that the jacket is preferably produced using the classic pultrusion method. Due to the improved mechanical interlocking of the surface of the composite profiled section with the jacket, a positive interlocking of the jacket with the composite profiled section is achieved, wherein a subsequent change in shape is prevented both during the hardening process and during storage and/or transport

The jacket is preferably applied to the composite profiled section by means of an extruder, wherein afterwards this pre-spring clip strand passes through a calibration basin in order to reshape the outer contour of the jacket. Preferably, the pre-spring clip strand is then led into at least one cooling basin to support the solidification of the pre-spring clip strand. In particular, no vacuum calibration is required because the composite profiled section provides sufficient support at the edge or outside and, in particular, prevents the jacket from collapsing.

In another advantageous embodiment of the method, it is planned that, in particular analogous to the extraction of the pre-composite profiled section, an extraction of the jacketed pre-spring clip strand by means of a second extraction device is performed.

Furthermore, in a preferred embodiment of the method for producing the spring clip strand, it is provided that the spring clip strand is separated and/or divided into individual spring clips by means of a separating device, in particular an accompanying separating device. This separating device can ultimately be designed as a sawing device and/or cutting device, whereby the strand of spring clips does not yet have to be completely hardened inside. An accompanying cutting device is preferred in order to ensure a continuous method sequence. The individual spring clips are used, for example, to later form a base springing for supporting a mattress and/or upholstery. In addition, the spring clip can preferably also be used for a supporting structure, in particular for the automotive and/or furniture industry.

In addition, the invention relates to a composite profiled section, in particular intended for use as a reinforcing element and/or reinforcing rod in a, preferably thermoplastic, plastic material and/or for use as a reinforcing rod for a spring clip, preferably produced by the above-mentioned method, having a core and a shell circumferentially surrounding the core, the core comprising and/or consisting of an extruded, in particular foamed, plastic.

The design of the core as a foam offers advantages, in particular in terms of production technology, since increased throughput speeds of inline production can be achieved in this way, advantageously for the production of a spring clip strand. In addition, material costs are saved because the material of the shell surrounding the core does not fill the entire composite profiled section. In particular, the same mechanical characteristics are achieved in comparison to a composite profiled section which is exclusively made of glass fibre reinforced plastic, so that the composite profiled section according to the invention in particular withstands the same load capacities. If a fibre-reinforced plastic material is used to manufacture the shell, up to 50% of the fibre-reinforced plastic material can be saved compared to the state of the art.

In addition, the composite profiled section according to the invention is lighter compared to a pipe, especially a rigid one made of fibre-reinforced plastic. In addition, improved bending properties of the composite profiled section are achieved. The extrusion of the core offers the advantage that the core can be produced cost-effectively and efficiently.

The preferred embodiments of the composite profiled section described below are to be understood in such a way that the properties of the composite profiled section can be realized primarily by the method according to the invention.

Preferably, by varying the wall thickness and/or the layer thickness application and/or the layer thickness of the shell, different, in particular mechanical, properties of the composite profiled section can be created, so that in particular also composite profiled sections with “soft” and/or “hard” spring properties can be provided by the design of the composite profiled section according to the invention.

In a preferred configuration of the present composite profiled section, the core is designed as a hollow body, preferably at least substantially as a hollow cylinder, in particular with a wall thickness greater than 1 mm, preferably greater than 2 mm, or as a solid body, preferably at least substantially in cylindrical form. In this context, the external diameter of the core may be less than or equal to 30 mm, preferably less than or equal to 20 mm, more preferably less than or equal to 15 mm and in particular less than or equal to 10 mm.

If the core is designed as a hollow cylinder and/or tubular, it can be seen that material can be saved in comparison to a solid body, which in particular reduces production costs. The core can be used to support and/or hold the shell surrounding it Consequently, the core has a structural function, although it does not have to compensate for the mechanical stresses of the composite profiled section.

Another aspect of this invention is that the core has a lower density and/or a lower weight per unit volume and/or a lower hardness and/or a lower stiffness, in particular a lower bending stiffness, than the shell. These properties make it clear that the mechanical loads are preferably absorbed by the shell surrounding the core, the core having in particular a supporting function for the shell.

The density is the quotient of its mass and its volume. It differs from the weight per unit volume, also known as bulk density and/or apparent and/or geometric density, since the weight per unit volume indicates the density of a porous solid based on the volume including the pore spaces. The difference between these two densities refers to the total porosity of the material.

The hardness, on the other hand, denotes the mechanical resistance of a body to the penetration of another body. The stiffness in contrast refers to the resistance of a body to elastic deformation by a force and/or by a moment, in particular a bending moment and/or torsional moment Due to the different moments acting on the body, various forms of stiffness are also known, including tensile, bending and torsional stiffness. The bending stiffness, in contrast, indicates how strong the absolute deflection and/or lowering of a body subjected to bending load is under a given load.

Preferably the material of the core has a lower strength and/or a lower bending strength than the material of the shell.

In contrast to the hardness, the strength refers to the material of the core, whereby it indicates the maximum load capacity that can be applied, so that deformation is avoided in particular.

The bending strength, analogous to the strength, also refers to the material of the core, where it indicates how high the prevailing tensile and/or compressive stresses are within the body loaded with a bending moment, so that, in particular, breakage or flow in the edge fibre is avoided.

Furthermore, the core preferably comprises a cross-linkable and/or a cross-linked material, preferably an elastomer and/or a thermosetting and/or thermoplastic material. Particularly preferably, the core comprises a thermoplastic material, in particular a semi-crystalline and/or amorphous thermoplastic material. The preferred material is polyethylene (PE).

The use of a thermoplastic foam, in particular semi-crystalline and/or amorphous, for the core offers the advantage that the production process is preferably simplified, since thermoplastic materials in particular are subject to lower environmental requirements than, for example, thermosetting materials.

Polyethylene foam is a closed-cell material with outstanding properties. In particular, low weight per unit volume, low density, low raw material consumption, excellent weathering and ageing resistances and/or good heat resistance are achieved. A sufficiently high heat resistance is necessary for the pultrusion of the composite profiled section. In addition, a core of polyethylene is deformable and can be fed into the continuous pultrusion process. In addition, good sound insulation and thermal insulation are advantageously ensured. In addition, PE foam has good mechanical damping, very good resistance to acids, alkalis and other chemicals and low water vapor permeability. Due to the low water permeability, there is in particular a reduced moisture absorption. Compared to thermoset foams, PE foam is particularly more environmentally friendly and has the advantage of lower material costs.

However, it is understood that ultimately other materials can also be used to produce the core, preferably in particular polystyrene (PS) and/or polyethylene terephthalate (PET) and/or polyvinyl chloride (PVC) and/or polypropylene (PP). Resin foams containing polyurethanes (PU) and/or foams containing phenoplasts (PF) in particular are possible as thermosetting foams.

Elastomeric materials are also conceivable, whereby the material can be both wide- meshed and close-meshed. In addition, thermoplastic materials with a higher melting temperature, such as polyamide (PA) and/or acrylonitrile-butadiene-styrene copolymers (ABS), which are extruded but not foamed in particular, can also be used.

The above-mentioned materials for the production of the core are preferably used in the above-mentioned method within the extrusion process for the production of the core.

Furthermore, tests have shown that the core has a volume weight greater than 180 kg/m3, preferably greater than 220 kg/m3, in particular greater than or equal to 250 kg/m3. These densities result in a very good porosity of the core, so that improved production properties and/or support properties of the core are achieved.

It should be noted in this connection that, analogous to the aforementioned method of producing the composite profiled section, at least one spirally shaped circulating supporting fibre can be provided on the outside of the shell. This supporting fibre determines the shape of the composite profiled section, so that another tool for shaping the composite profiled section can be omitted. Consequently, the shaping of the pre-composite profiled section according to the invention can be regarded as tool-free.

In the case of a preferred embodiment of the inventive idea, it is intended that the supporting fibre has and/or consists of a plastic material, in particular a synthetic polymer, preferably polyester. The polyester threads or polyester filaments and/or polyester fibres are technically advantageous, since they have only low material costs compared to glass fibres. Tests have shown that the use of polyester filaments leads to excellent forming properties of the pre-composite profiled section. In addition, the polyester fibre is preferably extremely tear- and abrasion-resistant, so that it can preferably be wound using a winding device. In addition, polyester is preferably heat-resistant, so that it does not liquefy, especially during later hardening of the pre-composite profiled section.

In addition, it is also possible to use aramides as a plastic material for the supporting fibre. Aramides are characterized by their toughness, tensile strength and low mass.

Furthermore, it has been shown that the supporting fibre preferably has a thickness and/or a size and/or a diameter of less than or equal to 1.5 mm, preferably less than 1 mm, further preferably less than 0.5 mm, in particular less than or equal to 0.1 mm. According to the invention, this low thickness of the supporting fibre offers the advantage that the material costs of the supporting fibre to be provided can be reduced, while at the same time an improved connection of the composite profiled section with the jacket for the production of a spring clip results.

In addition, tests carried out have shown that the distance between the windings of the supporting fibre on the composite profiled section is greater than or equal to 1 mm, preferably greater than or equal to 4 mm, further preferably greater than or equal to 6 mm and, in particular, at least substantially greater than or equal to 7 mm. This distance between the turns shown achieves the best possible mechanical connection between the composite profiled section and the jacket and determines the shape of the composite profiled section without using unnecessary material of the supporting fibre.

In particular, the composite profiled section may be compressed by the supporting fibre and may have a smaller outer diameter in the areas of the composite profiled section wrapped by the supporting fibre than in the areas not wrapped.

It goes without saying that the shell is preferably designed at least essentially as a hollow cylindrical tubular body, since the composite profiled section is also designed as a cylindrical tubular body because the core is in turn designed as a cylindrical body. The shape of the pre-composite profiled section is determined by the wrapping with the supporting fibre, whereby this production method can be used to produce rod-shaped composite profiled sections in particular.

Consequently, it results that the composite profiled section preferably has at least substantially the shape of a cylinder, in particular wherein the composite profiled section has an outer diameter smaller than or equal to 40 mm, preferably smaller than or equal to 16 mm, more preferably smaller than or equal to 15 mm and in particular at least substantially 14 mm. These dimensions of the composite profiled section are suitable for the production of various spring clips, wherein thicker composite profiled sections have a higher hardness and/or strength and therefore produce an increased hardness and/or strength of a spring clip. The use of smaller diameters results in material savings and thus a reduction in production costs. Tests have shown that the aforementioned geometric dimensions have excellent hardness and/or strength combined with low material and production costs.

Moreover, it was found that the shell preferably has a wall thickness greater than 0.3 mm, preferably greater than 0.8 mm, in particular greater than or equal to 1 mm. This advantageous wall thickness results in the mechanical strength of the composite profiled section at lower material costs. The lower the shell thickness, the less material is required for the composite profiled section to be produced. However, the shell thickness must be sufficiently large so that the composite profiled section can withstand mechanical loads, especially due to its shell.

In the case of an advantageous embodiment of the inventive idea, it is intended that the material of the shell comprises a plastic material reinforced with carbon and/or glass fibres and/or polymer fibres, preferably aramid fibres and/or textile fibres, in particular thermosetting and/or thermoplastic plastics, preferably polypropylene (PP), and/or epoxy and/or PU resin and/or polyester resin. It is particularly preferred if the material of the shell comprises glass fibres and, as plastic material, polyester resin. This material mixture of the shell results in a composite material, whereby the fibres are combined with a resin system, resulting in an extremely strong and/or stiff material. In particular, the fibres provide high tensile strength and/or compressive load. The resin, on the other hand, transfers the shear stresses of the composite profiled section to the entire cross-section. In particular, the specific properties of the shell can be designed to give very good chemical resistance and/or low weight and/or thermal and/or electrical insulation.

Finally, the invention concerns a spring clip with a composite profiled section and a jacket It is understood that the spring clip and/or the composite profiled section is/are produced according to the aforementioned method.

A polyester resin is the preferred material for the jacket. The use of polyester resins is particularly advantageous in that the polyester resin ensures increased hardness of the clip element In addition, polyester resin leads to low material costs and offers excellent fatigue resistance. The hardness of polyester resins can be realized in a wide range, especially when very hard polyester resins can be provided.

In another advantageous embodiment of the spring clip, the jacket has at least one leg, in particular a radially protruding leg. The leg in particular forms a lateral projection, which advantageously creates a wide contact surface on which in particular a cushion and/or mattress can be supported. A mirror-symmetrical profile cross-section is preferably provided, particularly with respect to a horizontal axis as well as a vertical axis.

This mirror-symmetrical configuration of the jacket prevents the profile from warping on one side in particular during the cooling process, as it has the same volumes of, in particular thermoplastic, material on both sides, wherein the legs are preferably subjected to the same cooling conditions.

By varying the wall thickness of the jacket and/or the shell of the composite profiled section, different properties can be produced in a bend, in particular so that corresponding “hard” and/or “soft” spring clips can be formed.

The connection of the composite profiled section with the jacket is advantageous because the external jacket is interlocked with the composite profiled section. The areas exposed by the wrapped composite profiled section are therefore filled with the material of the jacket, in particular a thermoplastic plastic. Consequently, a secure connection between the jacket and the core strand is preferred, which prevents the two components from separating from each other during a cooling and/or shrinking process. Once again, the supporting fibre has an advantageous shaping effect, as it prevents subsequent deformation, even during the rest of the hardening process.

Furthermore, the present invention concerns the use of the composite profiled section in accordance with the invention for connection with a fastening means. It is understood that the composite profiled section is designed according to one of the previously described embodiments. Ultimately, all the advantages described above and the preferred embodiment forms can also be applied to the use in accordance with the invention.

In particular, a screw can be used as a fastening means. Preferably, the fastening means is at least partially arranged in the core. The core therefore serves to hold the fastening means. In particular, a non-positive and/or positive connection is provided between the core and the fastening means, in particular so that there is a firm and at the same time detachable connection between the core and the fastening means. Ultimately, the core can serve as a kind of dowel which serves to hold the connecting means, in particular wherein the connecting means is firmly arranged in the core at least in certain areas. The material of the core, preferably the foam, can cling to and/or press against the fastening means and the fastening means in turn penetrates the material of the core and compresses it If the core is designed as a hollow body, it is understood that the fastening means can also be arranged in the range and/or within the free space resulting from the hollow cylindrical profile of the core. The core, which is designed as a hollow body, can therefore be designed as a thread in some areas.

According to the invention, the embodiment of the composite profiled section as core and shell can provide a connection option which is particularly suitable if the composite profiled section is used as a reinforcing rod and/or reinforcing element. When used as a reinforcing rod and/or reinforcing element, the composite profiled section is preferably provided with a thermoplastic and/or thermosetting protective shell and/or jacket Consequently, in addition to the reinforcement, the reinforcing rod and/or the reinforcing element can also be used as a connection option, resulting in a flexible use of the composite profiled section according to the invention.

According to the invention, there is a multitude of possible applications. Just to give an example, the composite profiled section, in particular the reinforcing rod and/or the reinforcing element with a thermoplastic and/or thermosetting protective shell, is used as a fence system and/or visual protection. Here it is understood that different reinforcing rods and/or reinforcing elements can be arranged next to each other and preferably connected to each other by means of fastening means.

The reinforcing rods and/or reinforcing elements can be arranged together via further connecting means, in particular branching means, preferably with a plurality of threads and/or openings for the arrangement of the composite profiled section and/or the reinforcing rod and/or the reinforcing element, for example a T-piece. In addition, the reinforcing rod and/or the reinforcing element with a preferably thermoplastic and/or thermosetting protective shell can be used as a roof support, in particular a motor vehicle roof support, in particular wherein the arrangement on the roof can be ensured via a frictional connection and/or a positive connection of the connecting means, preferably the screw, and the composite profiled section.

Furthermore, the aforementioned use of the composite profiled section can also be used in the area of base springing, in particular in a slatted frame system, and/or as a shelving system. In addition, the application possibility for undercut generation in injection molding is found.

In addition, it is understood that in the aforementioned intervals and range limits any intermediate intervals and individual intervals are contained and are to be regarded as essential to the invention, even if these intermediate intervals and individual values are not specified.

Further features, advantages and possible applications of the present invention result from the following description of examples of execution on the basis of the drawing and the drawing itself. All described and/or depicted features, either in themselves or in any combination, constitute the subject matter of the present invention, irrespective of their summary in the claims or their withdrawal.

It shows:

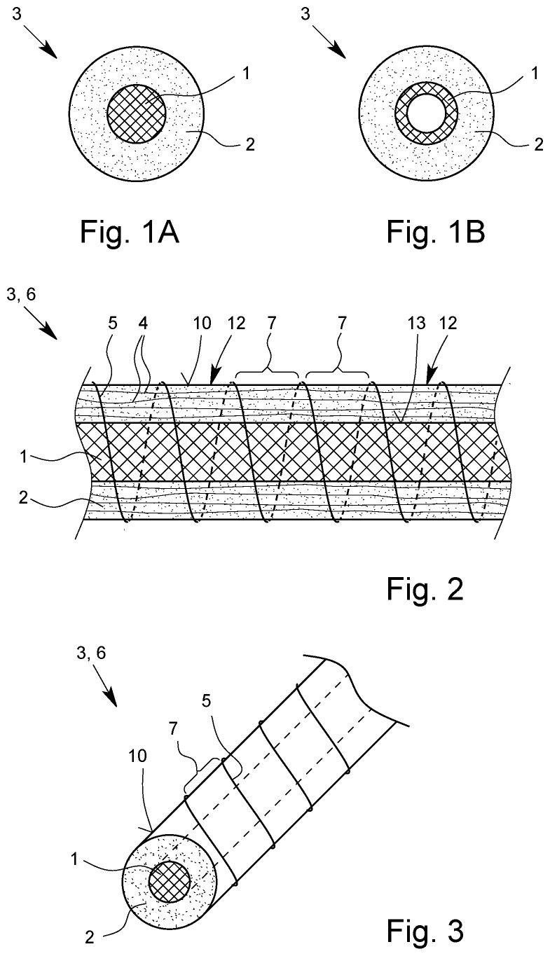

FIG. 1A a schematic cross-sectional view of a composite profiled section according to the invention;

FIG. 1B a schematic cross-sectional view of another embodiment of a composite profiled section according to the invention;

FIG. 2 a schematic view of a composite profiled section according to the invention;

FIG. 3 a perspective, schematic representation of a composite profiled section according to the invention;

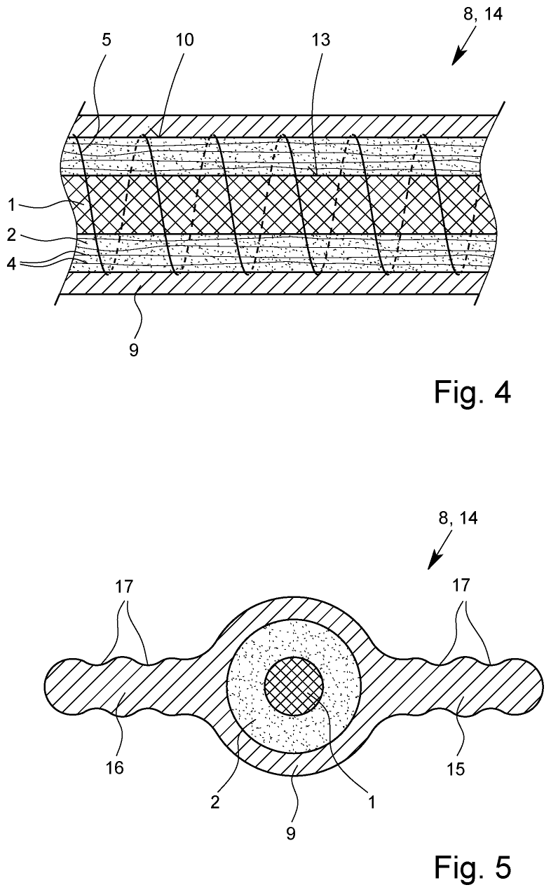

FIG. 4 a schematic longitudinal section of a spring clip according to the invention;

FIG. 5 a schematic cross-sectional view of a spring clip strand according to the invention and/or a spring clip according to the invention;

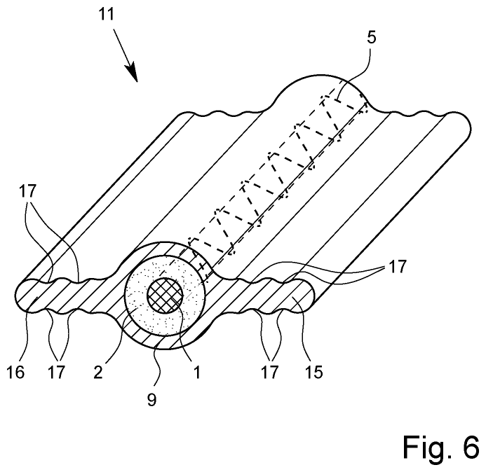

FIG. 6 a perspective schematic view of a spring clip according to the invention; and

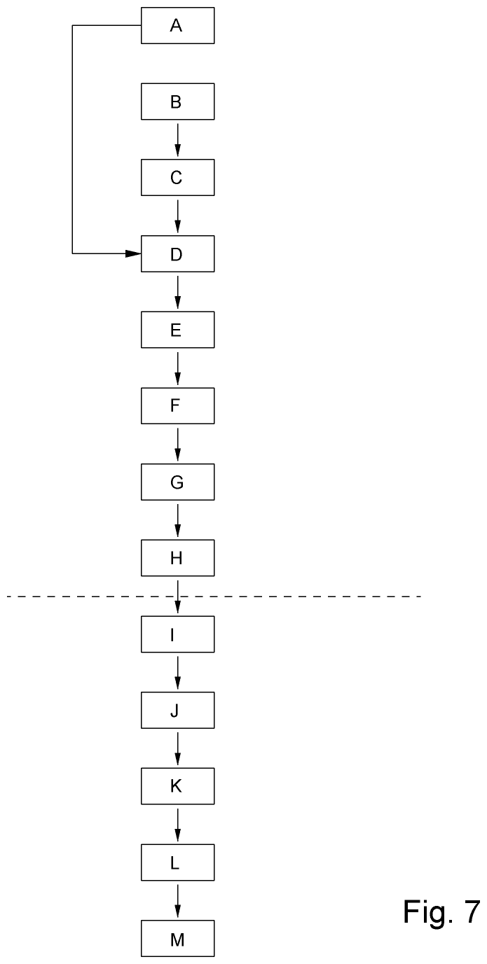

FIG. 7 A schematic method sequence for a method for producing a composite profiled section according to the invention or for producing a spring clip according to the invention.

The method according to the invention is explained below with reference to the schematic flow diagram according to FIG. 7 and with reference to FIGS. 1 to 6, wherein the machine according to the invention for the production of the composite profiled section 3 is not shown.

The composite profiled section 3 according to FIG. 1 has a core 1 and a shell 2 enveloping the core 1, the shell 2 having shell fibres 4 placed around the circumference of the core 1. According to the method, a first method variant provides that, following the application of the shell fibres 4 to the core 1, at least one supporting fibre 5 is wound around the applied shell fibres 4 by means of a winding device to produce a pre-composite profiled section 6. The pre-composite profiled section 6 differs from the composite profiled section 3 in that it has not yet hardened completely, wherein a preforming or a shaping is carried out by the supporting fibre 5. The outer wrapping of the shell 2 with the supporting fibre 5 is illustrated in FIGS. 2 and 3.

The supporting fibre 5 is laid around the shell 2 in such a way that an additional shaping by another shaping tool can be omitted. FIG. 2 illustrates that the supporting fibre 5 projects beyond the outside 10 of the shell 2 so that contours and/or recesses 12 result between the individual distances of the windings 7 on the outside 10 of the shell 2.

It is not shown that in another embodiment the material of the composite profiled section 3 can be compressed by the supporting fibre 5. With this embodiment not shown it is provided that the composite profiled section 3 has a reduced outer diameter in the areas wrapped by the supporting fibre 5. Instead of recesses 12 protrusions are provided for the non-wrapped areas of the composite profiled section 3.

Furthermore, it is not shown that compression can also be achieved by the supporting fibre 5 of the material of the shell 2 and/or the core 1 in the heating device.

There is no additional adhesive layer between core 1 and shell 2 in the example shown. In addition, a joint in shell 2 is also avoided, as it is provided according to the method that the strand of core 1 is continuously fed to the machine for the production of composite profiled section 3 in the inline method. The core 1 provides a supporting or holding function for the shell 2, with the core 1 not necessarily having to be integrally bonded to the shell 2.

In the method sequence in step A, it is provided in the exemplary embodiment shown that core 1 is first produced continuously by foam extrusion with at least one extruder. The extrusion of the core can also be provided independently and/or alternatively to the wrapping of the shell fibres 4 with the supporting fibre 5. The example shown in FIG. 7 finally shows a combination of both embodiments of the method.

The steps B and C according to FIG. 7 include the preparation of the shell 2, whereby the shell fibres 4 are spread out in a spreading device in step B. The spreading device comprises a fibre creel from which the individual shell fibres 4 are extracted, wherein, before entering the fibre creel, the shell fibres 4 have been stored on a coil creel in individual coils wound up. The individual shell fibres 4 are then treated in step C in an impregnating tank and/or in an impregnating bath, wherein the jacketing of each shell fibre 4 is covered with the material of the shell 2, in particular a plastic material.

The impregnating bath can be designed in such a way that the resin of the shell 2 in the impregnating bath is permanently liquid.

The core 1 produced in step A is fed in step D to the machine for producing the composite profiled section 3, the shell fibres 4 being laid around the core 1, preferably longitudinally in the production direction. The shell fibres 4 nest against the outside 13 of core 1 so that core 1 supports the shell fibres 4.

A shaping takes place in step E by wrapping the shell 2 on its outside 10 with at least one supporting fibre 5. The spirally shaped wrapping with the supporting fibre 5 causes the intermediate area, thus the recesses 12, to be free of the wrapping. The supporting fibre 5 is laid spirally shaped around the outside 10 of the shell 2 in the embodiment shown, so that the distance of the windings 7 is between 1 and 15 mm, in further versions between 2 and 10 mm. The resulting pre-composite profiled section 6 is therefore preformed.

When wrapping the pre-composite profiled section 6 with the supporting fibre 5, the pre-composite profiled section 6 is not yet fully hardened in the version shown, in particular the resin of the shell 2 is not yet hardened.

The pre-composite profiled section 6 wrapped with the supporting fibre 5 is fed to a heating device in step F so that the outside 10 of the shell 2 can harden.

A high heating temperature is required at the entry into the heating section in order to set the chemical reaction of the reaction resin, which leads to hardening, in motion very quickly. The temperature in the heating section is then kept as constant as possible in step G in order to maintain the initiated chemical reaction. The pre-composite profiled section 6 is guided through the heating section as contact-free as possible, if necessary supported on some supporting rollers, so that in contrast to pultrusion no high extraction forces are required.

After the heating section, in step H it is planned that either the composite profiled section 3 is completely hardened, wherein it can be separated into individual profiles by means of a separating device in accordance with an embodiment not shown, and thus can be temporarily stored.

In step H, it can also be provided that the pre-composite profiled section 6, which has not yet hardened completely, is fed to further devices for the production of a spring clip strand 8. It is not necessarily intended that the hardening reaction of the pre-composite profiled section 6 is complete. Despite the superficial external cooling of the shell 2, the exothermic hardening reaction, which takes place inside the pre-composite profiled section 6, is not interrupted.

Steps I to M include the production of a spring clip strand 8 and/or a spring clip 11. It is understood that in an exemplary embodiment not shown it can also be provided that the method is ended after step H, wherein the pre-composite profiled section 6 results in the composite profiled section 3 after complete hardening.

In the method procedure shown in FIG. 7, however, the production steps for producing a spring clip 11 are provided. In step I, the composite profiled section 3 is provided with a jacket 9 of the spring clip strand 8. It is intended that the composite profiled section 3 is continuously fed in the inline method to the production of the spring clip strand 8. The jacket 9 can be extruded onto the composite profiled section 3. The extrusion of the jacket 9 onto the composite profiled section 3 is a classic extrusion process sequence.

Consequently, after applying the jacket 9, the pre-spring clip strand 14 passes through a calibration basin in step J in order to reshape the outer contour of the jacket 9 and to support it during solidification. In step K, it is planned that the pre-spring clip strand 14 should pass through at least one cooling basin after the calibration basin, so that the jacket 9 is completely solidified. No vacuum calibration is provided and is also not necessarily required because the composite profiled section 3 acts sufficiently supportively and already prevents the jacket 9 from collapsing.

In step L, the extraction of the jacketed spring clip strand 14 is provided via at least one extraction device, after which the spring clip strand 14 is fed to a separating machine in step M. In a separating device not shown, the separating machine includes an accompanying sawing device in order to separate the individual spring clips 11 from the spring clip strand 8. The accompanying sawing device is necessary for a continuous inline method so that the process does not have to be interrupted.

In addition, a composite profiled section 3, which is intended for use in a spring clip 11, is provided in accordance with all the exemplary embodiments shown. In an exemplary embodiment (not shown), the spring clip 11 can be part of a slat base springing for supporting a mattress or cushion. The composite profiled section 3 is produced in the exemplary embodiment shown according to the above method and therefore has a core 1 and a shell 2 surrounding the core 1 circumferentially. The core 1 has an extruded, foamed plastic.

If composite profiled section 3 is not used as shown for a spring clip 11, in particular for the base springing, composite profiled section 3 or shell 2 adopts the load-bearing properties of the entire spring clip 11. The spring clip 11 shown in the exemplary embodiment achieves high load-bearing strengths when used as a base springing. The core 1 does not impair the load-bearing capacity, it serves only as a support and/or mounting function for the shell 2.

FIG. 1 shows that core 1 can be a solid body (FIG. 1A) or a hollow body (FIG. 1B). The wall thickness of a hollow body of core 1 according to FIG. 1B is greater than 1 mm, in other embodiments greater than 2 mm. The outer diameter of core 1 is less than or equal to 30 mm, in other embodiments less than or equal to 20 mm.

The core 1 has a material which is extruded and foamed in further embodiments. In addition, in the exemplary embodiment shown, core 1 has a thermoplastic material, in this case polyethylene (PE). Other thermoplastics such as polystyrene (PS) and/or polyethylene interrephthalate (PET) and/or polyvinyl chloride (PVC) and/or polypropylene (PP) and/or thermosetting plastics are also possible in the case of other embodiment variants not shown.

Furthermore, it is not shown that the material of core 1 has a cross-linked and/or cross-linkable material, where an elastomer and/or a thermoplastic and/or a thermosetting material can serve as the cross-linked or cross-linkable material. Polyamide (PA) and/or acrylonitrile-butadiene-styrene copolymers (ABS), which in particular are not foamed, can be used as material in even further embodiments. The porosity of core 1 can be characterized, among other things, by the weight per unit volume at a known density and/or pure density of the material of core 1. The density of core 1 is greater than 180 kg/m3, preferably greater than 220 kg/m3, in particular greater than or equal to 250 kg/m3.

To shape the composite profiled section 3, a spirally shaped supporting fibre 5 is provided around the outside 10 of the shell 2 as shown in FIGS. 2 and 3. The supporting fibre 5 completely takes over the shaping of the pre-composite profiled section 6. The supporting fibre 5 has a material made of plastic, in the example shown a synthetic polymer, here polyester. In an embodiment which is not shown, it is intended that the material should have and/or consist of aramide.

The height of the recesses 12 is determined by the size and/or thickness and/or by the diameter of the supporting fibre 5, the size and/or thickness and/or the diameter of the supporting fibre 5 is less than or equal to 1.5 mm, for other embodiments less than 0.3 mm. Accordingly, the maximum height of the recesses 12 in the exemplary embodiment shown is less than or equal to 1.5 mm.

In another embodiment (not shown), it is provided that the non-wrapped areas of the composite profiled section 3, which do not have a supporting fibre 5, have protrusions instead of recesses 12. The height of the protrusions may be greater than 0.3 mm, in other embodiments greater than or equal to 1.5 mm. A compression of the material of the composite profiled section 3 may be provided in the areas of the composite profiled section 3 wrapped by the supporting fibre 5.

The distance of the windings 7 of the supporting fibre 5 on the outside 10 of the shell 2 indicates the maximum possible distance between windings 7 with a shape of the pre-composite profiled section 6 to be obtained and a minimum consumption of material of the supporting fibre 5. The distance of the windings 7 is greater than or equal to 1 mm, for other embodiments greater than or equal to 4 mm and/or at least substantially greater than or equal to 7 mm.

FIG. 1 shows that the core 1 is formed as a circular tube, so that the composite profiled section 3 adopts at least substantially the shape of a cylinder by being folded over with shell fibres 4, wherein the composite profiled section 3 has an outer diameter of less than or equal to 40 mm, in the case of further embodiment variants less than or equal to 16 mm and/or at least substantially less than or equal to 14 mm. The difference between the external diameter of the composite profiled section 3 and the external diameter of the core 1 results in twice the wall thickness of the shell 2. The wall thickness of the shell 2 is greater than 0.3 mm in this case and greater than 0.8 mm in the case of further embodiment variants.

By different wall thicknesses of the shell 2 it is possible to create different properties when bending a spring clip 11, so that corresponding “hard” and “soft” spring clips can be formed.

In the exemplary embodiment shown, the material of shell 2 is a polyester resin reinforced with glass fibres. In the case of further embodiment variants not shown, the use of a material which has a plastic material reinforced with carbon fibres and/or polymer fibres, preferably aramid fibres and/or textile fibres, is provided, wherein it is possible that thermosetting plastics and/or thermoplastic plastics and/or epoxy resin and/or polyurethanes (PU) having resin may be provided. Polypropylene (PP) can be provided as a material for a thermoplastic synthetic material.

Furthermore, in the exemplary embodiment shown, a spring clip 11 is shown, which has a composite profiled section 3 with a jacket 9. The jacket 9 has a thermoplastic plastic. In the case of other embodiments which are not clearly specified, the use of a thermosetting and/or other thermoplastic is intended. In the example shown, it is intended that the thermoplastic plastic has polypropylene (PP).

The material of the jacket 9 lays itself around the outside 10 of the shell 12 of the composite profiled section 3 and/or in the recesses 12. The jacket 9 completely surrounds the composite profiled section 3. The spring clip strand 8 is shown in FIG. 5 and/or the spring clip 11 is shown in FIGS. 5 and 6. By filling the recesses 12 with the material of the jacket 9, a mechanical interlocking and/or toothing of the external shell 2 of the composite profiled section 3 with the jacket 9 is created. This secure connection prevents these two components from separating from each other and/or from shifting against each other due to different shrinkage behavior when cooling the thermoplastic jacket 9 and the composite profiled section 3. In the embodiment variant shown, the method does not necessarily require a complete hardening of the composite profiled section 3 before being fed into the extrusion machine of the jacket 9 for the production of the spring clip strand 8, so that the hardening process continues inside the composite profiled section 3 under certain circumstances after the spring clip strand 8 has been produced. However, due to the positive interlocking of the jacket 9 with the composite profiled section 3, subsequent deformation is also prevented during the remaining hardening process during storage or transport

At this point, however, it should be noted that the pre-composite profiled section 6 has already been dimensionally stable in its original form due to the supporting fibre 5. The composite profiled section 3 is stable against buckling. The subsurface layers of the composite profiled section 3 are hardened before entering the extrusion machine of the jacket 9 and easily withstand the melt pressure of the extrusion machine.

According to FIGS. 5 and 6, it is clear from the spring clip 11 that the jacket 9 has at least one radially projecting leg 15. In the version shown, the jacket 9 has one leg 15, 16 each on opposite sides. The legs 15, 16 of the finished spring clip 11 provide an enlarged contact surface of the base springing for a mattress or for a cushion. The mechanical loads of the spring clip 11 are absorbed and compensated by the jacket 9 and/or shell 2. The bearing strength is mainly and/or exclusively taken over by the shell 2.

The core 1 does not have to take any load, it serves as a support and/or holding function for the shell 2. The jacket 9 is arranged symmetrically in relation to a horizontal and in relation to a vertical cross-section axis, so that accumulation of material on one side in the cross-section is prevented, whereby deformations of the spring clip during subsequent cooling are avoided. The legs 15, 16 have a rounded, elongated, elliptical-shaped cross-sectional shape. They also have two recesses 17 in the embodiment shown, but these can also be omitted. According to FIG. 5, the recess 17 has an arc-shaped cross-sectional shape and thus creates a wave-shaped end of the legs 15, 16 in the cross-sectional view.

It is not shown that the composite profiled section 3 can be used for connection with a fastening means, in particular a screw. Furthermore, it is not shown that the connection means can be arranged at least partially in the core 1. This applies both to the configuration of core 1 as a solid body and as a hollow body. In the case of a hollow body design, the free area and/or hollow cavity of core 1 can ultimately serve as a thread for the fastening means. In the end, the core 1 of the composite profiled section 3 acts as a kind of dowel for the fastening means.

In this context, it is understood that a plurality of composite profiled sections 3 and/or spring clips 11 and/or reinforcing rods and/or reinforcing elements exhibiting the composite profiled section 3, preferably with a thermoplastic and/or thermosetting jacket 9 and/or protective shell, can also be arranged against each other by means of further connecting means. Thus, it may be provided that a connecting means, in particular a screw or the like, is arranged in the core 1 and at the same time also in a further connecting means, in particular a branching means, for connection to further reinforcing rods and/or reinforcing elements and/or spring clips 11 and/or composite profiled sections 3. The branching means may have a plurality of openings for arrangement

In addition, the possible application areas of the composite profiled section 3 are not shown. In particular, it is not shown that the composite profiled section 3 and/or the spring clip 11 and/or the reinforcing element and/or the reinforcing rod with a preferably thermoplastic and/or thermosetting protective jacket or jacket 9 can be used as a fence system, visual protection, roof support, base springing, in particular slatted frame system, shelving system and/or for undercut creation in injection molding.

### REFERENCE CHARACTER LIST

1 Core

2 Shell

3 Composite profiled section

4 Shell fibres

5 Supporting fibre

6 Pre-composite profiled section

7 Distance of windings

8 Spring clip strand

9 Jacket

10 Outside of the shell

11 Spring clip

12 Recesses

13 Outside core

14 Pre-spring clip strand

15 Leg

16 Leg

17 Recesses

1. A method for the production of a composite profiled section having a core and a shell for use as a reinforcing element, as a reinforcing rod in a thermoplastic or plastic material, or for the use as a reinforcing rod for a spring clip, the method comprising placing a plurality of shell fibres around a circumference of the core; and winding at least one supporting fibre around the placed shell fibres by means of a winding device for the production of a preformed pre-composite profiled section.

2. The method according to claim 1, wherein the core is fed as a strand in an inline method.

3. The method of claim 1, further comprising the step of continuously producing the core by foam extrusion with at least one extruder.

4. The method of claim 1, wherein the step of winding at least one supporting fibre further comprises spirally winding at least one supporting fibre with a distance between adjacent windings between 1 and 15 mm.

5. The method of claim 1, further comprising the steps of: producing a spring clip strand from the composite profiled section by an inline method; and extruding a jacket on the composite profiled section.

6. A composite profiled section for use as a reinforcing element or reinforcing rod in a thermoplastic or plastic material or for use as a reinforcing rod for a spring clip, the composite profiled section comprising a core and a shell circumferentially surrounding the core, wherein the core is an extruded plastic.

7. The composite profiled section of claim 6, wherein the core has a cylindrical hollow body with a wall thickness greater than 1 mm wherein the outer diameter of the core is less than or equal to 30 mm.

8. The composite profiled section of claim 6, wherein the core comprises a cross-linkable or cross-linked material, having a density of greater than 180 kg/m³.

9. The composite profiled section of claim 6 wherein at least one spirally shaped encircling supporting fibre is provided on an outside surface of the shell, the supporting fibre selected from one of: a synthetic polymer, a polyester, and an aramid.

10. The composite profiled section of claim 9, wherein the supporting fibre has a diameter of less than or equal to 1.5 mm, and where in the at least one spirally shaped encircling supporting fibre has windings that are spaced greater than or equal to 1 mm from one another.

11. The composite profiled section of claims 6, wherein the composite profiled section is cylindrical with an outer diameter smaller than or equal to 40 mm.

12. The composite profiled section of claim 6, wherein the shell has a wall thickness greater than 0.3 mm, and the shell is constructed from one or more of the following materials: carbon fibres, glass fibres, polymer fibres, aramid fibres, textile fibres, glass fibres, reinforced plastic material, thermosetting plastics, thermoplastic plastics, polypropylene, epoxy resin, a polyurethane, comprising resin, and polyester resin.

13. The composite profiled section of claim 6, wherein a composite profiled section has a thermoplastic or thermosetting jacket and the composite profiled section is used in a spring clip.

14. The composite profiled section of claim 6, wherein a connecting means is arranged at least partially in the core.

15. The composite profiled section of claim 14 where in the connecting means is a screw.

16. The composite profiled section of claim 6, wherein the core is a foamed plastic material.

17. The composite profiled section of claim 8, wherein the core material is selected from one or more of the following materials: an elastomer, a thermosetting material, or a thermoplastic material.

18. The composite profiled section of claim 17, wherein the core material is an amorphous thermoplastic material selected from one of the following: polyethylene, polystyrene, polyethylene terephthalate, polyvinyl chloride, and polypropylene.

19. The composite profiled section of claim 6, where in the core is a cylindrical solid body having an outer diameter less than or equal to 30 mm.

20. The composite profiled section of claim 9 wherein the composite profiled section is cylindrical having a diameter of less than or equal to 14 mm, the core is cylindrical and has diameter less than or equal to 10 mm, and the at least one supporting fibre has a diameter less than or equal to 1.5 mm, wherein the at least one supporting fibre is spirally wound around the core as windings such that windings are spaced greater than or equal to 1 mm from one another.
